(19) United States
(12) Patent Application Publication
(10) Pub. No.: US 2026/0185880 A1
(43) Pub. Date: Jul. 2, 2026

(54) TEMPERATURE DETECTION MODULE AND CHARGING DOCK

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Tiancheng Cao, Suzhou (CN); Renyi (Ronny) Dou, Suzhou (CN); Jinshun (Jet) Wang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/436,332

(22) Filed: Dec. 30, 2025

(30) Foreign Application Priority Data
Dec. 31, 2024 (CN) 202411996994.7

(51) Int. Cl. G01K 1/14; G01K 1/02; H02J 7/70

(52) U.S. Cl. CPC G01K 1/14; G01K 1/026; H02J 7/70

(57) ABSTRACT

A temperature detection module includes an insulation shell, a circuit board installed into the insulation shell, a thermal pad installed on the circuit board, a temperature sensor provided in the thermal pad and mounted on the circuit board, and an external pin installed on the circuit board. The temperature detection module is installed in a plug-in manner from an outside into an insertion slot in a charging dock housing. The thermal pad is in thermal contact with a power terminal inside the charging dock housing when the temperature detection module is installed in the insertion slot to transfer heat of the power terminal to the temperature sensor. The temperature sensor detects a temperature of the power terminal and is electrically connected to the external pin through a conductive trace on the circuit board. The external pin is electrically connected with a connector located outside the charging dock housing.

### CROSS-REFERENCE TO RELATED APPLICATION

This application claims the benefit of the filing date under 35 U.S.C. § 119(a)-(d) of Chinese Patent Application No. 202411996994.7, filed on Dec. 31, 2024.

### FIELD OF THE INVENTION

The present invention relates to the field of electric vehicle charging technology, particularly to a temperature detection module and a charging dock comprising the temperature detection module.

### BACKGROUND OF THE INVENTION

In order to charge the battery pack of new energy electric vehicles, it is necessary to install a charging dock suitable for mating with a charging gun on the new energy electric vehicle. In order to improve charging speed, it is necessary to increase the charging current. Currently, the charging current is as high as 600 A, and it may even increase to 1000 A in the future. When a large current flows through the power terminal inside the charging dock, a large amount of heat is generated, which can cause the temperature of the power terminal inside the charging dock to rise sharply. If the temperature rise cannot be controlled in time, it can lead to safety accidents, such as burning the charging dock or other electrical equipment.

In order to control the temperature rise of power terminals, a lead frame is usually installed in the charging dock and a temperature detection module is integrated on the lead frame. The temperature detection module includes a temperature sensor and a thermal pad wrapped around the outside of the temperature sensor. The thermal pad is in thermal contact with the power terminal, and the temperature sensor is electrically connected to the lead frame. However, the lead frame has a large volume and needs to be pre-installed in the charging dock housing, which is very inconvenient to use. In addition, in order to facilitate the installation of lead frame, the charging dock housing needs to adopt a split design, which leads to a complex structure of the charging dock housing. In addition, the existing lead frame needs to be able to rotate between a locking position of locking the power terminal and an unlocking position of unlocking the power terminal, which will make the lead frame and charging dock housing more complex, assembly more difficult, and cost higher.

### SUMMARY OF THE INVENTION

A temperature detection module includes an insulation shell, a circuit board installed into the insulation shell, a thermal pad installed on the circuit board, a temperature sensor provided in the thermal pad and mounted on the circuit board, and an external pin installed on the circuit board. The temperature detection module is installed in a plug-in manner from an outside into an insertion slot in a charging dock housing. The thermal pad is in thermal contact with a power terminal inside the charging dock housing when the temperature detection module is installed in the insertion slot to transfer heat of the power terminal to the temperature sensor. The temperature sensor detects a temperature of the power terminal and is electrically connected to the external pin through a conductive trace on the circuit board. The external pin is electrically connected with a connector located outside the charging dock housing.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a temperature detection module according to an exemplary embodiment of the present invention when viewed from one side;

FIG. 2 shows an illustrative exploded view of a temperature detection module according to an exemplary embodiment of the present invention when viewed from one side;

FIG. 3 shows an illustrative perspective view of a temperature detection module according to an exemplary embodiment of the present invention when viewed from the other side;

FIG. 4 shows an illustrative exploded view of a temperature detection module according to an exemplary embodiment of the present invention when viewed from the other side;

FIG. 5 shows an exploded sectional view of a temperature detection module according to an exemplary embodiment of the present invention;

FIG. 6 shows an assembly sectional view of a temperature detection module according to an exemplary embodiment of the present invention;

FIG. 7 shows an illustrative view of the circuit board, temperature sensor, thermal pad, and external pins of a temperature detection module according to an exemplary embodiment of the present invention;

FIG. 8 shows an illustrative perspective view of a charging dock according to an exemplary embodiment of the present invention;

FIG. 9 shows an illustrative exploded view of a charging dock according to an exemplary embodiment of the present invention;

FIG. 10 shows an exploded sectional view of a charging dock according to an exemplary embodiment of the present invention; and

FIG. 11 shows an axial sectional view of a charging dock according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

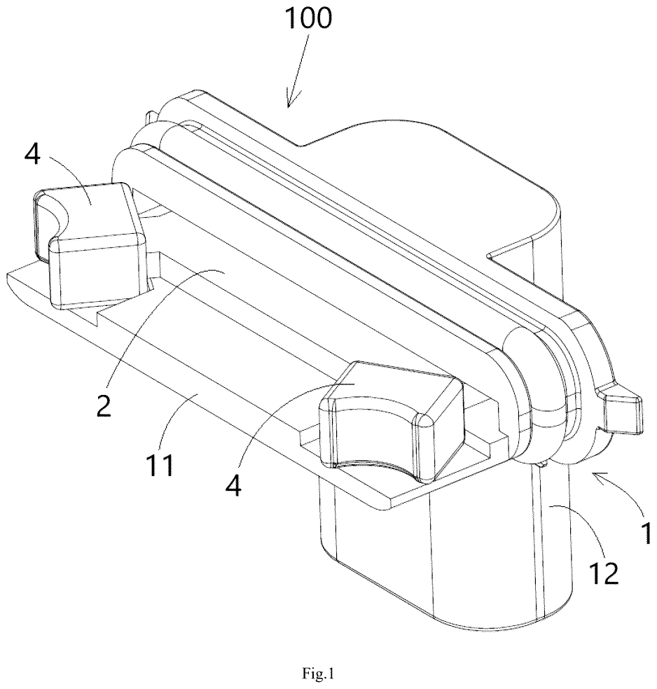

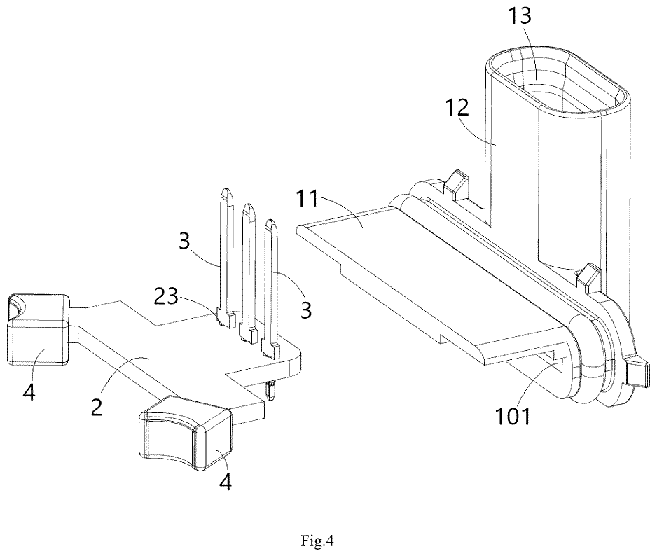

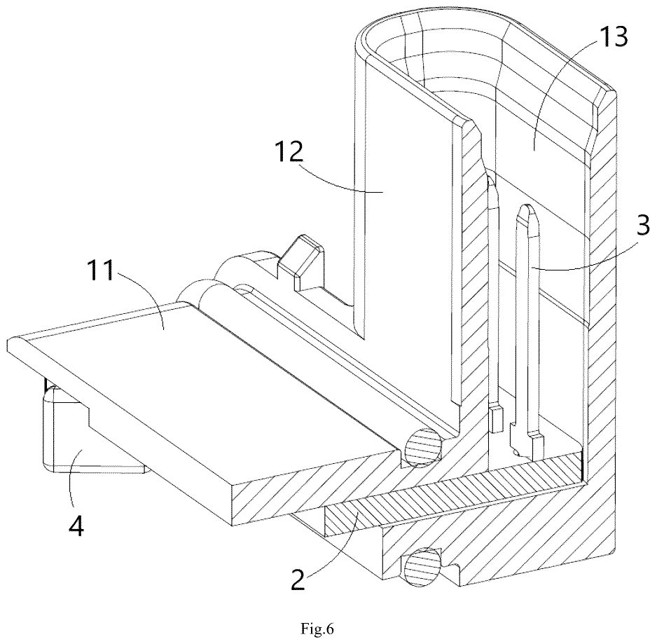

As shown in FIGS. 1 to 7, in an exemplary embodiment of the present invention, a temperature detection module 100 is disclosed. The temperature detection module 100 includes an insulation shell 1, a circuit board 2, a thermal pad 4, a temperature sensor 5, and an external pin 3. The circuit board 2 is installed into the insulation shell 1. The thermal pad 4 is installed onto the circuit board 2. The temperature sensor 5 is provided in the thermal pad 4 and mounted on the circuit board 2. The external pin 3 is installed onto the circuit board 2.

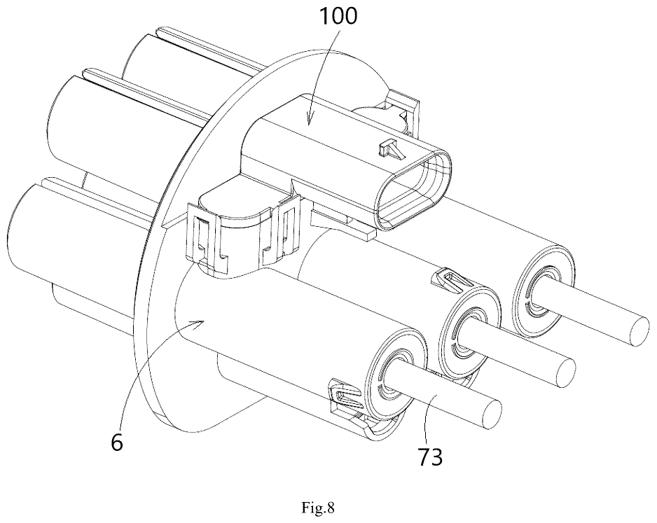

As shown in FIGS. 8 to 11, in the illustrated embodiment, the temperature detection module 100 is adapted to be installed in a pluggable manner from the outside into an insertion slot 62 in the charging dock housing 6. When the temperature detection module 100 is installed in the insertion slot 62, the thermal pad 4 comes into thermal contact with a power terminal 70 inside the charging dock housing 6 to transfer the heat of the power terminal 70 to the temperature sensor 5. The temperature sensor 5 is used to detect the temperature of the power terminal 70 and is electrically connected to the external pin 3 via a conductive trace on the circuit board 2. The external pin 3 is used to electrically connect with a connector located outside the charging dock housing 6.

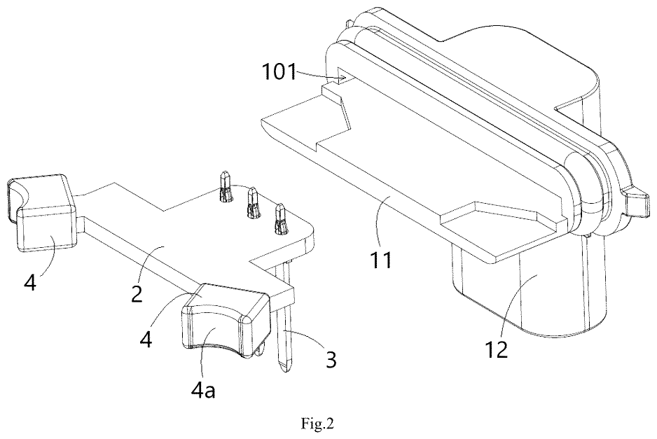

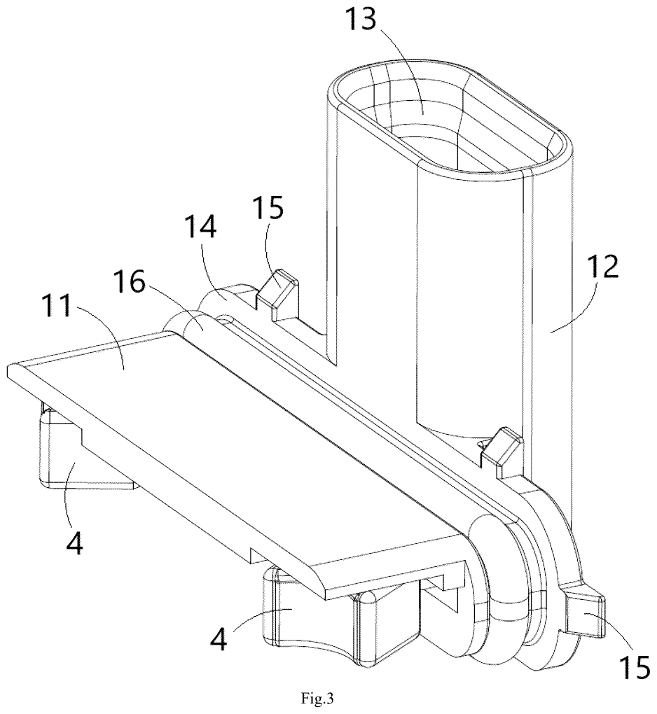

As shown in FIG. 2, in the illustrated embodiment, the insulation shell 1 includes an installation part 11 and a mating part 12. The installation part 11 is suitable for inserting into the insertion slot 62 of the charging dock housing 6. The mating part 12 is adapted to be positioned on the outside of the charging dock housing 6. A mounting slot 101 is formed in the installation part 11, and the circuit board 2 is inserted into the mounting slot 101 of the installation part 11. The mating part 12 has an insertion cavity 13, shown in FIG. 3, that allows the connector to be inserted, and the external pin 3 is located in the insertion cavity 13 to electrically connect with the inserted connector. In the illustrated embodiment, the insulation shell 1 is an integral injection molded part. This can reduce manufacturing costs.

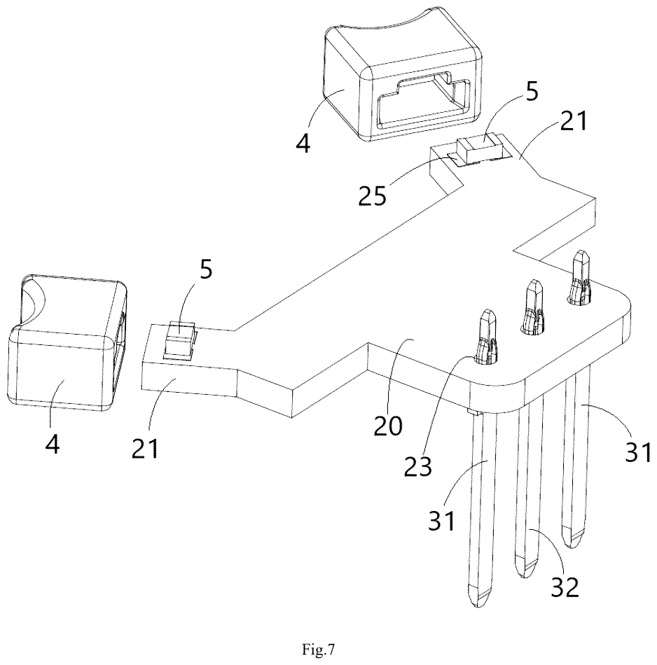

As shown in FIG. 7, in the illustrated embodiment, a solder pad 25 and a conductive hole 23 are formed on the circuit board 2. The solder pad 25 is electrically connected to the conductive hole 23 via a conductive trace. The temperature sensor 5 is a surface mounted temperature sensor and is soldered to the solder pad 25. One end of the external pin 3 is inserted and soldered into the conductive hole 23.

As shown in FIG. 7, in the illustrated embodiment, the circuit board 2 includes a plate-shaped body 20 and a protruding part 21 protruding from the plate-shaped body 20. The temperature sensor 5 is mounted on the protruding part 21, and the thermal pad 4 is cap shaped and fitted onto the protruding part 21 and the temperature sensor 5.

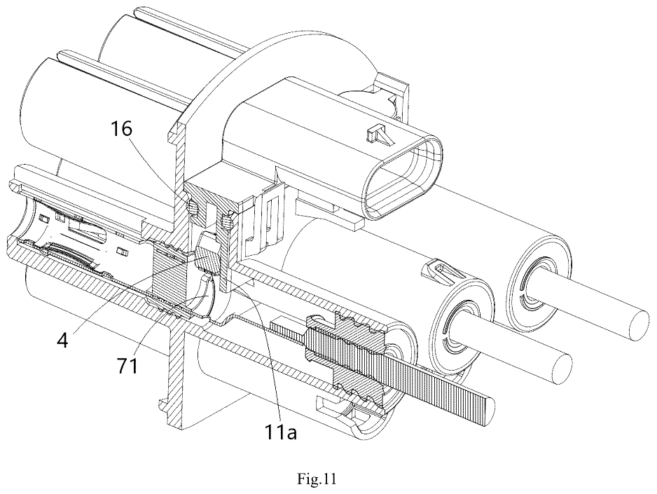

As shown in FIG. 2, in the illustrated embodiment, the thermal pad 4 has an arc-shaped contact surface 4a located outside the insulation shell 1, which is suitable for being pressed against the outer peripheral surface of the power terminal 70, as shown in FIG. 11, to increase the thermal contact area between the thermal pad 4 and the power terminal 70.

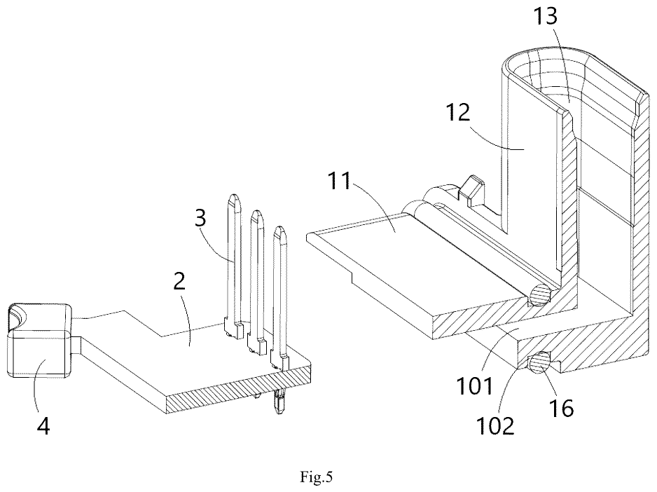

As shown in FIG. 5, in the illustrated embodiment, a sealing ring installation groove 102 is formed on the outer peripheral surface of the installation part 11 of the insulation shell 1. The temperature detection module 100 also includes a sealing ring 16 installed in the sealing ring installation groove 102, which is suitable for being compressed between the installation part 11 and the inner wall surface of the insertion slot 62 of the charging dock housing 6 to achieve sealing between the two.

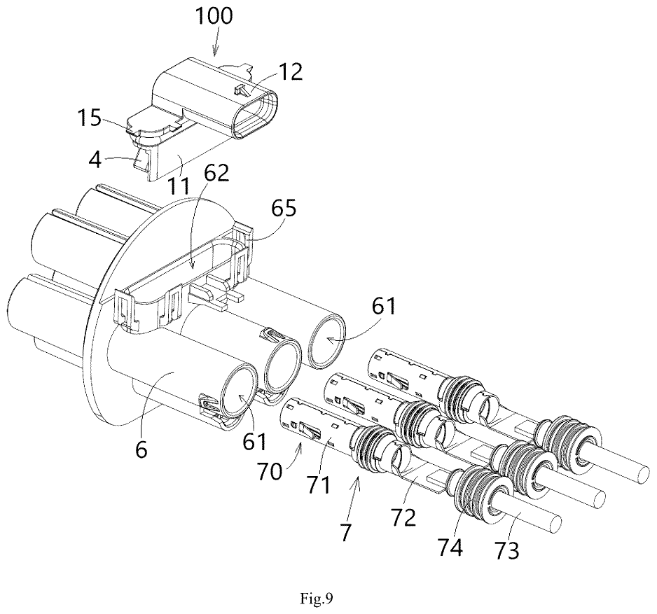

As shown in FIG. 3, in the illustrated embodiment, the installation part 11 has a cover plate part 14 for covering the entrance of the insertion slot 62 of the charging dock housing 6. Multiple protrusions 15 are formed on the outer peripheral surface of the cover plate part 14, which are distributed around the outer periphery of the cover plate part 14 and are used to engage with multiple buckles 65 on the charging dock housing 6, respectively, as shown in FIGS. 8 and 9, to lock the temperature detection module 100 into the insertion slot 62 of the charging dock housing 6.

As shown in FIG. 7, in the illustrated embodiment, the temperature detection module 100 includes multiple thermal pads 4 and multiple temperature sensors 5 respectively arranged in the multiple thermal pads 4. The multiple thermal pads 4 are used to make thermal contact with multiple power terminals 70, as shown in FIG. 11, and the multiple temperature sensors 5 are used to detect the temperature of the multiple power terminals 70.

As shown in FIG. 7, in the illustrated embodiment, the external pin 3 includes multiple positive pins 31 and a single negative pin 32. The multiple positive pins 31 are respectively electrically connected to the positive terminals of multiple temperature sensors 5, and the single negative pin 32 is simultaneously electrically connected to the negative terminals of multiple temperature sensors 5. However, the present invention is not limited to the illustrated embodiment. For example, in another exemplary embodiment of the present invention, the external pin 3 includes multiple positive pins 31 and multiple negative pins 32. The multiple positive pins 31 are respectively electrically connected to the positive terminals of multiple temperature sensors 5, and the multiple negative pins 32 are respectively electrically connected to the negative terminals of multiple temperature sensors 5.

In another exemplary embodiment of the present invention, the thermal pad 4 may be injection molded onto the circuit board 2 and the temperature sensor 5, so that the circuit board 2, the temperature sensor 5, and the thermal pad 4 become an integral piece.

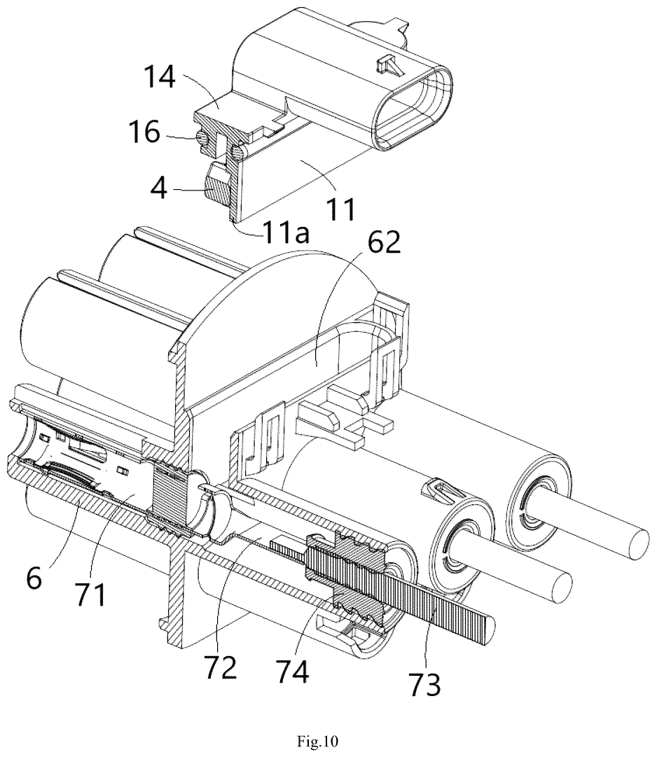

As shown in FIGS. 10 and 11, in the illustrated embodiment, when the temperature detection module 100 is inserted into the insertion slot 62 of the charging dock housing 6, the edge part 11a of the insulation shell 1 simultaneously presses against the multiple power terminals 70 inside the charging dock housing 6 to lock the multiple power terminals 70 in the charging dock housing 6.

In another exemplary embodiment of the present invention, a charging dock is also disclosed. As shown in FIGS. 8 to 11, the charging dock includes: a charging dock housing 6, a terminal assembly 7, and a temperature detection module 100. The charging dock housing 6 is formed with a terminal socket 61 and an insertion slot 62 communicated with the terminal socket 61. The terminal assembly 7 includes a power terminal 70 and is inserted into the terminal socket 61. The temperature detection module 100 is inserted into the insertion slot 62 from the outside of the charging dock housing 6. The thermal pad 4 of the temperature detection module 100 is in thermal contact with the power terminal 70 to transfer the heat of the power terminal 70 to the temperature sensor 5.

As shown in FIG. 9, in the illustrated embodiment, a plurality of buckles 65 are formed on the outer side of the peripheral wall of the insertion slot 62 of the charging dock housing 6, and the multiple buckles 65 are distributed around the insertion slot 62 at intervals for respectively engaging with the multiple protrusions 15 on the insulation shell 1 of the temperature detection module 100 to lock the temperature detection module 100 in the insertion slot 62.

In the illustrated embodiment, the axial direction of insertion slot 62 is perpendicular to the axial direction of terminal socket 61, and the temperature detection module 100 is inserted into the insertion slot 62 along the radial direction of the terminal socket 61.

As shown in FIG. 9, in the illustrated embodiment, the power terminal 70 includes a cylindrical part 71 and a connection part 72. The cylindrical part 71 is used for mating with a mating power terminal. The connection part 72 is connected to the rear end of the cylindrical part 71 for electrical connection to a cable 73. The edge part 11a of the insulation shell 1 of the temperature detection module 100 is axially pressed against the rear end surface of the cylindrical part 71 of the power terminal 70 to lock the power terminal 70 in the terminal socket 61.

As shown in FIGS. 9 and 10, in the illustrated embodiment, the terminal assembly 7 further includes a cable 73 and a sealing plug 74. The cable 73 is electrically connected to the connection part 72 of the power terminal 70. The sealing plug 74 is fitted onto the cable 73 and inserted into the rear port of the terminal socket 61. The terminal assembly 7 is inserted through the rear port of terminal socket 61, and the sealing plug 74 is used to seal the rear port of terminal socket 61. In the illustrated embodiment, the connection part 72 of the power terminal 70 is flat and welded to the conductor end of the cable 73.

As shown in FIG. 9, in the illustrated embodiment, the charging dock housing 6 has multiple terminal sockets 61, and the charging dock has multiple terminal assemblies 7 that are respectively inserted into the multiple terminal sockets 61. The insertion slot 62 is communicated with multiple terminal sockets 61, and the temperature detection module 100 includes multiple thermal pads 4 in thermal contact with the power terminals 70 of multiple terminal assemblies 7, and multiple temperature sensors 5 for detecting the temperature of the multiple power terminals 70. The edge part 11a of the insulation shell 1 of the temperature detection module 100 is simultaneously pressed against multiple power terminals 70, locking the multiple power terminals 70 in the charging dock housing 6 at the same time.

In the illustrated embodiment, the charging dock housing 6 is an integral injection molded part. This can reduce manufacturing costs and improve production efficiency.

In the aforementioned exemplary embodiments according to the present invention, the temperature detection module is not only small in size, but also can be directly inserted into the insertion slot in the charging dock housing from the outside, making its installation and use very convenient.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A temperature detection module, comprising:
an insulation shell;
a circuit board installed into the insulation shell;
a thermal pad installed on the circuit board;
a temperature sensor provided in the thermal pad and mounted on the circuit board; and
an external pin installed on the circuit board, the temperature detection module is adapted to be installed in a plug-in manner from an outside into an insertion slot in a charging dock housing, the thermal pad is in thermal contact with a power terminal inside the charging dock housing when the temperature detection module is installed in the insertion slot to transfer heat of the power terminal to the temperature sensor, the temperature sensor detects a temperature of the power terminal and is electrically connected to the external pin through a conductive trace on the circuit board, the external pin is electrically connected with a connector located outside the charging dock housing.

2. The temperature detection module according to claim 1, wherein the insulation shell comprises:
an installation part insertable into the insertion slot of the charging dock housing; and
a mating part positioned outside the charging dock housing, a mounting slot is formed in the installation part, the circuit board is inserted into the mounting slot of the installation part, the mating part has an insertion cavity that allows the connector to be inserted, the external pin is located in the insertion cavity to be electrically connected to the connector.

3. The temperature detection module according to claim 1, wherein a solder pad and a conductive hole are formed on the circuit board, the solder pad is electrically connected to the conductive hole through the conductive trace, the temperature sensor is a surface mounted temperature sensor and is soldered to the solder pad, an end of the external pin is inserted and soldered into the conductive hole.

4. The temperature detection module according to claim 1, wherein the circuit board has a plate-shaped body and a protruding part protruding from the plate-shaped body, the temperature sensor is mounted on the protruding part, the thermal pad is cap shaped and fitted onto the protruding part and the temperature sensor.

5. The temperature detection module according to claim 1, wherein the thermal pad has an arc-shaped contact surface located on an outside of the insulation shell, the arc-shaped contact surface abuts against an outer peripheral surface of the power terminal to increase a thermal contact area between the thermal pad and the power terminal.

6. The temperature detection module according to claim 2, wherein a sealing ring installation groove is formed on an outer peripheral surface of the installation part of the insulation shell, and further comprising a sealing ring installed in the sealing ring installation groove, the sealing ring is pressed between the installation part and an inner wall surface of the insertion slot of the charging dock housing to achieve sealing between the installation part and the charging dock housing.

7. The temperature detection module according to claim 2, wherein the installation part has a cover plate part covering an entrance of the insertion slot of the charging dock housing, and a plurality of protrusions are formed on an outer peripheral surface of the cover plate part, the protrusions are distributed around an outer periphery of the cover plate part and respectively engage with a plurality of buckles on the charging dock housing to lock the temperature detection module into the insertion slot of the charging dock housing.

8. The temperature detection module according to claim 1, wherein the thermal pad is one of a plurality of thermal pads and the temperature sensor is one of a plurality of temperature sensors respectively arranged in the thermal pads, the power terminal is one of a plurality of power terminals and the thermal pads respectively make thermal contact with the power terminals, the temperature sensors respectively detect a temperature of the power terminals.

9. The temperature detection module according to claim 8, wherein the external pin has a plurality of positive pins and a single negative pin, the positive pins are respectively electrically connected to a plurality of positive terminals of the temperature sensors, and the single negative pin is simultaneously electrically connected to a plurality of negative terminals of the temperature sensors.

10. The temperature detection module according to claim 8, wherein the external pin has a plurality of positive pins and a plurality of negative pins, the positive pins are respectively electrically connected to a plurality of positive terminals of the temperature sensors, and the negative pins are respectively electrically connected to a plurality of negative terminals of the temperature sensors.

11. The temperature detection module according to claim 1, wherein the thermal pad is injection molded onto the circuit board and the temperature sensor, the circuit board, the temperature sensor, and the thermal pad are an integral piece.

12. The temperature detection module according to claim 1, wherein, when the temperature detection module is inserted into the insertion slot of the charging dock housing, an edge part of the insulation shell is pressed against the power terminal inside the charging dock housing to lock the power terminal in the charging dock housing.

13. A charging dock, comprising:
a charging dock housing having a terminal socket and an insertion slot communicated with the terminal socket;
a terminal assembly inserted into the terminal socket, the terminal assembly including a power terminal; and
a temperature detection module inserted into the insertion slot from an outside of the charging docket housing, the temperature detection module including:
an insulation shell;
a circuit board installed into the insulation shell;
a thermal pad installed on the circuit board;
a temperature sensor provided in the thermal pad and mounted on the circuit board; and
an external pin installed on the circuit board, the thermal pad is in thermal contact with the power terminal inside the charging dock housing when the temperature detection module is installed in the insertion slot to transfer heat of the power terminal to the temperature sensor, the temperature sensor detects a temperature of the power terminal and is electrically connected to the external pin through a conductive trace on the circuit board, the external pin is electrically connected with a connector located outside the charging dock housing.

14. The charging dock according to claim 13, wherein a plurality of buckles are formed on an outer side of a peripheral wall of the insertion slot of the charging dock housing, the buckles are distributed around the insertion slot at intervals for respectively engaging with a plurality of protrusions on the insulation shell of the temperature detection module to lock the temperature detection module in the insertion slot.

15. The charging dock according to claim 13, wherein an axial direction of the insertion slot is perpendicular to an axial direction of the terminal socket, the temperature detection module is inserted into the insertion slot along a radial direction of the terminal socket.

16. The charging dock according to claim 15, wherein the power terminal includes a cylindrical part matable with a mating power terminal and a connection part connected to a rear end of the cylindrical part for electrical connection to a cable, an edge part of the insulation shell of the temperature detection module is axially pressed against a rear end surface of the cylindrical part of the power terminal to lock the power terminal in the terminal socket.

17. The charging dock according to claim 16, wherein the terminal assembly includes a cable electrically connected to the connection part of the power terminal and a sealing plug fitted onto the cable and inserted into a rear port of the terminal socket, the terminal assembly is inserted through the rear port of the terminal socket, and sealing plug seals the rear port of the terminal socket.

18. The charging dock according to claim 13, wherein the terminal socket is one of a plurality of terminal sockets of the charging dock housing and the terminal assembly is one of a plurality of terminal assemblies respectively inserted into the terminal sockets, the insertion slot is communicated with the terminal sockets.

19. The charging dock according to claim 18, wherein the thermal pad is one of a plurality of thermal pads of the temperature detection module and the temperature sensor is one of a plurality of temperature sensors of the temperature detection module, the thermal pads are respectively in thermal contact with the power terminals of the terminal assemblies and the temperature sensors for respectively detecting the temperatures of the power terminals.

20. The charging dock according to claim 13, wherein the charging dock housing is an integral injection molded part.
